(19) United States
(12) Patent Application Publication
(10) Pub. No.: US 2012/0312633 A1
(43) Pub. Date: Dec. 13, 2012

(54) Roof Strap Anchor Safety System

(76) Inventor: Thomas Massey, Smyma, TN (US)

(21) Appl. No.: 13/314,654

(22) Filed: Dec. 8, 2011

Related U.S. Application Data
(60) Provisional application No. 61/494,686, filed on Jun. 8, 2011.

(51) Int. Cl. A62B 35/00

(52) U.S. Cl. 182/3

(57) ABSTRACT

Disclosed is a new fall prevention and roof safety device, comprising an elongated strap adapted to span between two gutters and run along a roof surface. The strap employs a pair of ratchet straps, a central D-ring positioned at the strap midlength for placement over the ridge of a pitched roof, and a pair of gutter hooks at each end of the strap. The D-ring is adapted for attachment of a safety line, while the gutter hooks comprise substantially C-shaped hooks and an opening to secure around a gutter, securing against a roof soffit without placing load directly onto the gutter. Optionally, a gutter wedge, comprising a block adapted to fit within the gutter interior, may be used for structures that do not have adequate soffit attachment clearance for a gutter hook. The disclosed safety device can be quickly installed and removed without using nails, screws, or other permanent fixturing.

### CROSS REFERENCE TO RELATED APPLICATION

This application claims the benefit of U.S. Provisional Application No. 61/494,686 filed on Jun. 8, 2011, entitled “Roof Strap Anchor.”

### BACKGROUND OF THE INVENTION

1. Field of the Invention

The present invention relates to a safety device for workers. More specifically, the present invention pertains to a fall restraint device to prevent workers from falling from a roof.

In the construction industry, falling at a worksite is the leading cause of worker fatalities. According to OSHA, between 150 and 200 workers are killed, and more than 100,000 are injured as a result of falls at construction sites each year. This is particularly true for roof workers, who face a variety of obstacles that can lead to injury, including the pitch of the roof, rain, snow, or frost that may cause slippery conditions, dirt or sawdust, improper footwear, and tripping hazards such as tools, or electric cords.

To prevent such injuries, OSHA has set uniform standards for roof workers. OSHA requires that workers engaged in roofing activities on sloped roofs with unprotected sides that are 6 feet or more off the ground must be protected from falling by guardrail systems, safety net systems, personal fall arrest systems, or a combination thereof. There are a variety of safety systems available; however, many are time consuming to install, and further cause damage to the support structure, thereby costing employers and consumers time and money. This is particularly true with roofs that do not have a location to attach the fall prevention equipment. In such cases, a fall prevention system requires the use of nails, screws, or other types of fasteners for installation. These fasteners can cause damage to a roof and also reduce the security and effectiveness of the equipment.

The present invention improves upon fall prevention devices with a system that can be quickly installed on a flat or pitched roof without causing damage thereto and without requiring permanent modification of the roof to install the safety device. The device comprises a pair of elongated safety straps with specialized gutter hooks on opposing ends. The gutter hooks contain an opening that is large enough to secure over a gutter and abut against the roof soffit, positioned interior of the gutter, without placing load directly onto the gutter. Optionally, a gutter wedge can be used for structures that do not have adequate attachment along the roof soffit. The gutter wedge inserts into the gutter cavity and provides a stable grounding for the strap to support a worker in the case of a fall. The straps further include a centrally located D-ring for attachment of a safety line, wherein the D-ring is preferably positioned over the ridge of a pitched roof or in the center of a flat roof, wherein connection of a safety line is provided thereto. The D-ring is located along the central strap midlength, while two lengths of adjustable straps on either end of the central strap allow adjustment between two opposing gutters using strap ratchets to tension the device therebetween. The device is adapted to be easily applied and removed from a roof without the use of nails, screws, or other permanent fasteners or fixtures.

2. Description of the Prior Art

Several devices have been disclosed in the art that attempt to prevent roof workers from falling. Crocker, U.S. Pat. No. 5,036,949 discloses a motion-stopping safety system with a gripping anchor that has a C-shaped body member with facing members secured thereto and a line connection device. Burdet, U.S. Patent Application No. 2006/0032703 discloses an anchor assembly for preventing a user from falling from an object, comprising: a strap; a mechanism for retaining the strap on the object; and at least one anchor point on the strap to which the user can secure. Baake, U.S. Patent Application No. 2007/0272485 discloses a low-profile roof safety device, and kit of parts therefor, for grasping the apex of an angled roof. The roof safety device includes a body with frictional contact surfaces, a cord, and a harness. While these devices include safety straps and harnesses, their means of attaching to a structure substantially differs from the present invention, in that it does not utilize a hook that attaches over a roof soffit, thereby preventing contact with the gutter. Similarly, the disclosed prior art patents does not utilize a gutter wedge as an embodiment of their roof attachment means.

Other patents disclose fall prevention systems that require installation of large support structures that are secured to a roof. Beard, U.S. Pat. No. 5,730,246 discloses a fall protection system that includes a mast assembly resting on the ground and contacting a soffit of the roof. A cable support structure is secured to the mast assembly. A cable is connected at a first end to the cable support structure and includes a first portion extending upwardly from the cable support structure toward a peak of the roof and a second portion extending downwardly from the peak toward the ground and terminating at a second end. The second portion is adapted to connect to a harness secured to the worker. A weight hangs from the second end of the cable to hold the cable taut. Glynn, U.S. Pat. No. 5,143,171 discloses a lifeline safety system for a pitched roof that employs a frame for mounting a lifeline system above the peak of the roof. An anchor comprising a generally J-shaped bolt secures the bracket assembly to the roof. Systems such as these require significant amounts of time to install, and require the use of permanent installations or fasteners that can cause damage to the roof.

Also disclosed in the prior art are ratcheting straps with hooks on opposing ends. Huck, U.S. Pat. No. 7,789,603 discloses a retractable tie down device comprising a frame, a spool including a ratchet wheel rotatably mounted to the frame, a flexible web having one end mounted to the spool, a power spring configured to rotate the spool in a web take-up direction, a handle movably mounted to the frame, a ratchet pawl movably mounted to the handle and biased toward the ratchet wheel, and a lock pawl movably mounted to the frame and biased toward the ratchet wheel. Ratcheting straps such as these are not adapted to attachment to a roof soffit and do not include a D-ring for attachment of a safety line.

While the devices in the art are well adapted for their given requirements and fulfill a need, they share common drawbacks. These devices require a significant amount of time to install, and do not utilize gutter hooks that attach over a gutter and against a roof soffit for preventing contact with the gutter, or alternatively a gutter wedge for locations without an exposed soffit. The present invention utilizes a unique design that is quickly installable on a roof and protects the roof and gutters from damage in the case of a fall, while providing a means to support a fallen user to prevent injury. The present invention substantially diverges in design elements from the prior art and consequently it is clear that there is a need in the art for an improvement to existing fall prevention devices. In this regard the instant invention substantially fulfills these needs.

### SUMMARY OF THE INVENTION

In view of the foregoing disadvantages inherent in the known types of fall prevention devices now present in the prior art, the present invention provides a new fall prevention device wherein the same can be utilized for providing convenience for the user when working on a roof where the use of fall prevention equipment is required.

It is therefore an object of the present invention to provide a new and improved fall prevention and roof safety device that has all of the advantages of the prior art and none of the disadvantages.

Another object of the present invention to provide a new and improved fall prevention device that supports a user while on a pitched or flat roof surface and prevents the user from falling to the ground if a fall occurs.

Another object of the present invention is to provide a new and improved fall prevention device that can support a worker and arrest his or her fall without permanent, intrusive or time-consuming hardware installations on the roof structure.

Yet another object of the present invention is to provide a new and improved fall prevention device that can be secured around a gutter and abut against the roof soffit to prevent contact with the gutter while supporting load from a fallen user. This prevents the hooks from bearing into the gutter, thereby preventing damage thereto or removal thereof from the house. The soffit attachment location further provides a more stable and secure attachment location for supporting a user and breaking his or her fall without introducing the risk of the strap becoming dislodged from its installed position.

Another object of the present invention is to provide a new and improved fall prevention device that includes an optionally installed gutter wedge for installation in locations without an exposed roof soffit in order to support the roof strap with a gutter attachment means that is adapted to secure within the cavity of the gutter and bear against the inner surface of the gutter when load is applied to the strap.

A further object of the present invention is to provide a new and improved fall prevention device that utilizes a central strap and a pair of ratchet adjusters located at both ends thereof, which secure to adjustable lengths and allow the device to span between gutters and along roofs of varying width, and further allowing the application of tension through the strap for secure fitment therebetween.

Another object of the present invention is to provide a new and improved fall prevention device that utilizes a centrally located D-ring along the central strap for attachment of a safety line thereto, whereby the line is connect to the safety strap and affixes to a harness worn by a user. The D-ring is fixed in its location between the ratchet straps, and preferably over the ridge of a pitched roof. Alternatively, a slideable D-ring is contemplated for allowing improved movement of the user with respect to the D-ring location along the strap.

Still another object of the present invention is to provide a new and improved fall prevention device that does not require the use of nails, screws, or any other permanent fixturing on a roof to install.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention, including a strap with a pair gutter hooks at opposing ends.

FIG. 2 shows a perspective view of an alternate embodiment of the present invention, including a strap with a pair of gutter wedges at opposing ends.

FIG. 3 shows a perspective view of the present invention, including the strap installed on a roof with a worker secured thereto.

FIG. 4 shows a cross-sectional side view of the present invention and its hook attachment around a gutter and securing against a roof soffit.

### DETAILED DESCRIPTION OF THE INVENTION

Reference is made herein to the attached drawings. Like reference numerals are used throughout the drawings to depict like or similar elements of the fall prevention device. For the purposes of presenting a brief and clear description of the present invention, the preferred embodiment will be discussed as used with gutter hooks installed for attaching to a roof. The figures are intended for representative purposes only and should not be considered to be limiting in any respect.

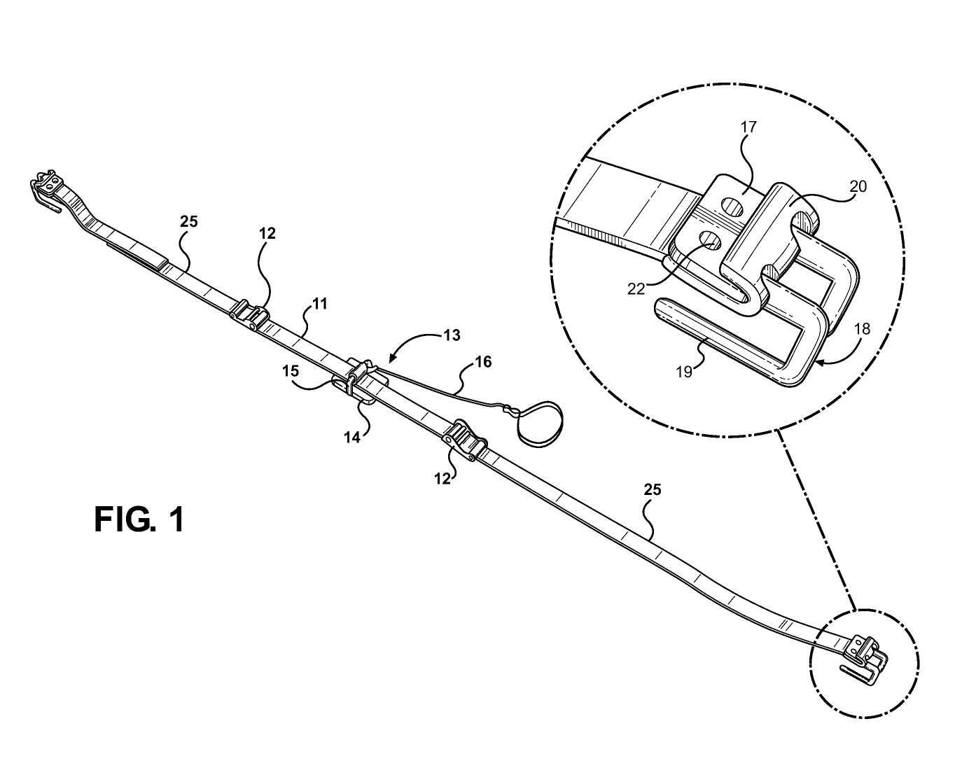

Referring now to FIG. 1, there is shown a perspective view of the present invention, including an elongated, segmented roof strap that is designed to span from one soffit to another along a flat or pitched roof of a house or similar building. The segmented roof strap comprises a centrally located strap 11 that connects to a pair of strap tensioner means 12 at each of its terminal ends. Two adjustable strap lengths 25 are provided on either end of the central strap 11 and extend outwardly from the tensioner means 12, which are preferably a pair of ratchet tensioners. The ratchet tensioners 12 provide a means to cinch the adjustable segments 25 of the strap tightly against the roofline and secure the device firmly between two opposing gutters. At the midlength of the central strap 11 is a safety line D-ring 13 that is positioned equidistant from the ratchets 12. The D-ring is preferably secured to the central strap 11 and prevented from moving, wherein it is adapted to be placed over the ridge of a pitched roof. The central strap 11 is designed to be shorter than the adjustable lengths 25, allowing a user to place the D-ring 13 at the midpoint of the roof and cinch the adjustable lengths 25 from one location to tension the device between two opposing soffits. A safety line attaches from the D-ring 13 and to a user. The line preferably attaches to a harness worn by a user or to an otherwise secure location, such as a belt or similar member that is capable of withstanding loads imparted thereon in the event of a fall from the roof. The length of the safety line is adapted to allow the user to walk along the roof unencumbered, allowing for fore-aft and lateral movement away from the strap while affording protection that prevents the user from touching the ground in the event of a fall.

On either terminal end of the roof strap adjustable lengths 25 is a gutter attachment means. In a particular embodiment, an enlarged C-shaped hook 18 is provided at each end of the strap to fit around a roof gutter and secure against a roof soffit. A hook receiver 20 at each end of the strap, comprising a U-shaped fitting, supports a bridge 17 that provides connection to a first and second hook 19. The hooks 19 are placed through apertures in the hook receiver 20, while the bridge 17 and hook receiver 20 are optionally fastened together using a plurality of aligned fastener engagement holes 22. If fastening is not desired, the roof strap 11 may be tightened after the two are engaged, whereby the tension created in the strap pulls the hook receiver 20 against the hook bridge 17 and secures the two together during operation. The hooks and hook bridge are formed together in a permanent configuration, and are removable from the hook receiver assembly 20 as a single piece. The strap and hook receiver 20 are likewise permanently affixed to one another. The removability of the hook 16 and the provided universal receiver 20 at the strap terminal ends allows a user to select an appropriate means for securing the present invention to a roof. This creates a roof safety and fall prevention system that can be installed on a variety of roofs that contain different attachment means without requiring additional straps. The design of the hook may be adapted for a specific roof geometry, wherein another style hook is placed in connection with the hook receiver 20 and either fastened or tensioned as a composite assembly.

The gutter hook 18 of the present invention is designed to attach to a roof while transferring the load around an existing gutter and through the roof soffit, which is a more secure attachment location. The gutter hook 18 comprises a pair of substantially C-shaped prongs and an internal opening large enough to secure around the exterior of a gutter without making contact therewith. To secure the gutter hook 18 to the roof, the lower portion 19 of the gutter hook 18 is placed against the roof soffit beneath the gutter and transfers load around the gutter and to the soffit when installed. This prevents the gutter from bearing any of the loads created by the strap 11 tension or in the instance a worker falls from the roof. The gutter hook 18 further comprises a pair of apertures 22 for threadably attaching to the hook receiver 17 if a more permanent connection is desired between the two components. This allows a worker to securely install the gutter hooks 18, or optionally remove the hooks in favor of a secondary attachment means, depending on the installation requirements.

The roof strap of the present invention is similar in design to a an elongated ratchet strap, which is a reinforced, high tension webbing that is used to cinch down and secure objects to structural tie down locations. The strap can be made from a variety of high tensile strength and durable materials, the most common being nylon or polypropylene. Any type of strap that is strong enough to arrest a user fall from a roof is contemplated. A poly strap may further be is used because of the inclusion of ultraviolet inhibitors, which prevent the webbing from breaking down when exposed to sunlight. This allows for repeated use of the strap 11 without degradation since the strap 11 is exposed to the sun when in use on a roof. The strap of the present invention comprises three main sections: a central strap 11 and two adjustable length sections 25 attached together using a pair of ratchet adjusters. The composite nature of the strap allows the central strap to be located at the center of the roof between two soffits, while the adjustable lengths are tensioned between each end of the central strap the end roof soffits.

The pair of strap ratchets 12 are conventional tensioner means that coil a length of the strap and are well known in the art. The ratchet 12 is a type of tensioner that utilizes a rotating mechanism to coil the strap length and remove slack along the line until the desired level of tension is obtained. Traditional ratchet straps utilize a single ratchet to tension a given strap. The present invention, however, utilizes two ratchets 12 and composite sections of strap lengths to allow a user to center a continuous section of the roof strap 11 along the roof line to allow the D-ring 13 to be centrally located therealong, while the ends of the strap allow length adjustment and a means to develop tension without moving the D-ring 13 location.

Positioning the strap ratchets 12 equidistantly and within close proximity to the D-ring 13 allows adjustment of the overall length of the strap without compromising the location of the D-ring 13 during this operation. In a preferred embodiment, the D-ring 13 has a flat back plate with an upstanding ring 15 that provides an opening for receiving the safety strap 16 carabineer or clip. The opening created by the upstanding ring 15 allows for a conventional safety line to be attached thereto. A safety line is used in order to absorb the weight of a fallen worker and arrest his fall from the roof, wherein load is transferred through the safety line 16 and to the D-ring 13, and finally through the tensioned strap to the roof soffits. The end of the safety line 16 is adapted to be connected to a harness worn by a user. In an alternate embodiment of the D-ring 13, rather than being fixed along the central strap 11, it may be adapted to slide between the first and second ratchet tensioners 12, along the length of the central strap 11. This embodiment allows a worker to manually move the D-ring 13 along the length of the device between ratchets 12 and expand his or her working area, while maintaining a given length of safety line 16.

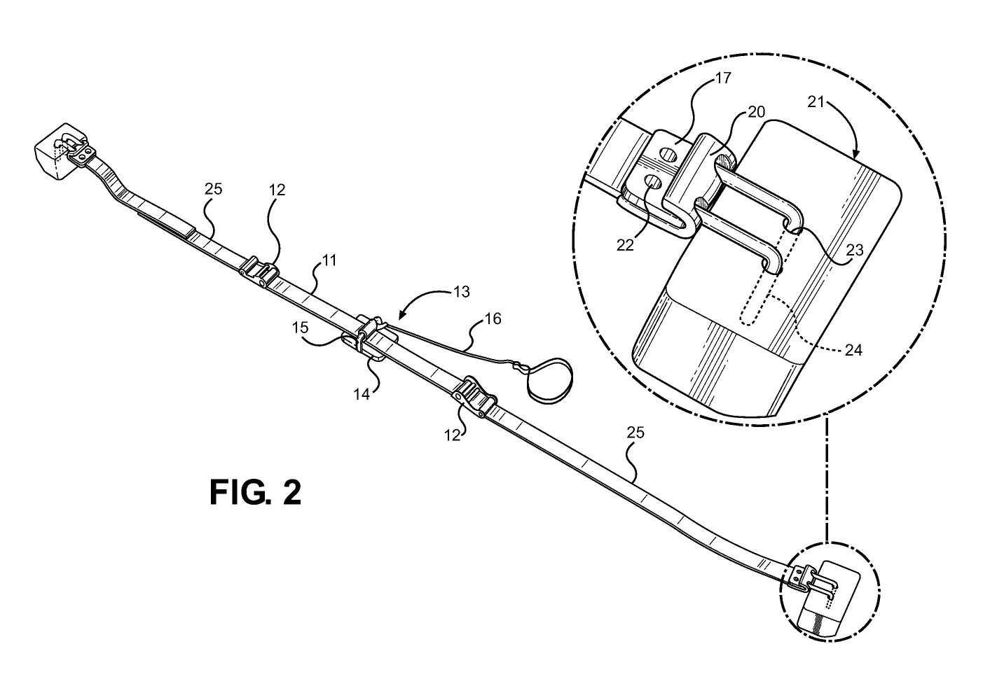

Referring now to FIG. 2, there is shown a perspective view of an alternate embodiment of the present invention, comprising an elongated, composite roof strap, a pair of ratchet tensioners 12, a D-ring 13 for attaching a safety line, a U-shaped receiver 20 at each terminal end of the strap, and a pair of gutter wedges 21 at opposing ends. The gutter wedge 21 is shaped to fit within the interior of a gutter during operation, and is useful for installing the present invention on a roof without an exposed roof soffit that could otherwise be used as an attachment point using the disclosed C-shaped hooks. In such a circumstance, the gutter wedge 21 is placed inside a gutter to secure the roof strap 11 in place. The wedge 21 transfers load onto the interior side of the gutter where it is attached to the fascia of the roof. In this way, the fascia bears the load of the device when tensioned or arresting a fall, instead of the gutter cross section. This minimizes the possibility of damaging the gutters since it is not directly bearing load created by the strap or from a fallen roof worker.

Similar to the gutter hook 18 as shown in FIG. 1, the gutter wedge embodiment utilizes the same U-shaped receivers 20 at either end of the strap. An L-shaped hook device 24 having a similar hook bridge 17 as the preferred embodiment is secured to the receiver 20 in a similar fashion, either fastened or through strap tension. The lower ends of the L-shaped hooks 24 are placed into apertures 23 that run through the gutter wedges and secure the hooks in place therein. The interchangeability of this system allows a worker to install or remove either attachment, or to add a separate attachment to create a secure and safe fall prevention system.

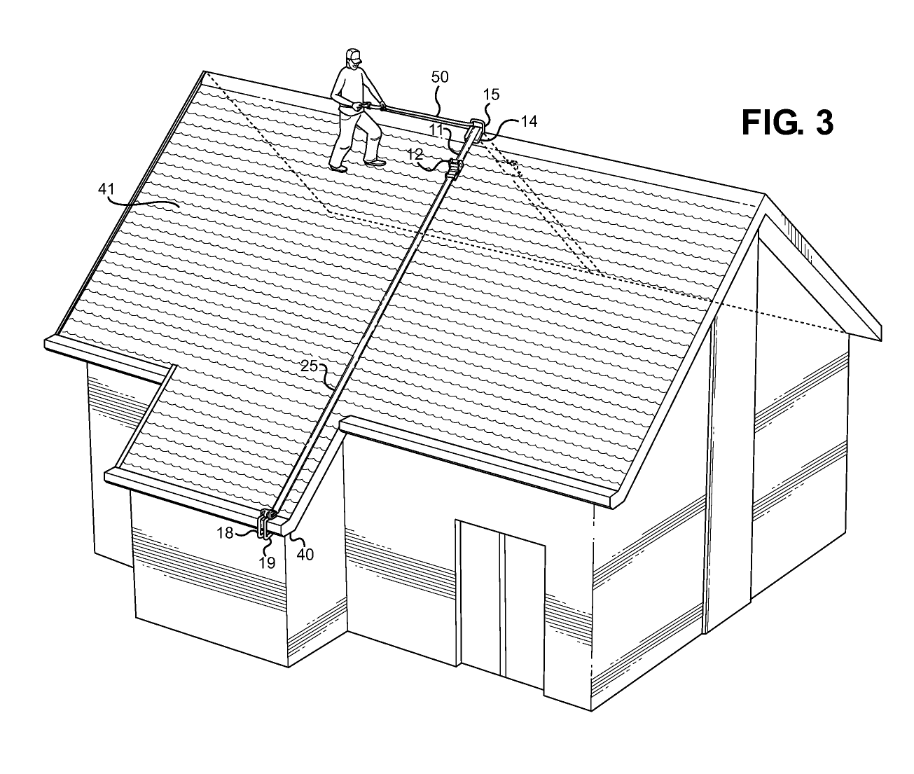

Referring now to FIG. 3, there is shown a perspective view of the present invention in use, including the strap 11 and the gutter hook 18 embodiment attached to a roof and roof soffit. To install the device as shown, each gutter hook 18 is attached to the soffit 40 on opposing sides of the roof 41. The excess strap 25 is pulled through the ratchets 12 until the required tension is achieved. This is accomplished by positioning the central strap 11 along the ridge or midwidth of the roof, while excess strap 25 is pulled through the ratchets 12 in order tension the assembly along the roof surface and between two opposing soffits. This allows for proper positioning of the central strap 11 and allows the D-ring 13 be positioned centrally on the roof. As shown, the D-ring 13 is positioned at the ridge of the roof 41; however it can be positioned as required by the worker between the first and second soffit locations 40 on any particular roof.

In cases where a worker falls and begins to slide down the pitch of the roof 41, the attached safety line 50 arrests the worker's fall by loading the D-ring 13 and tensioned length of strap 11, 25. In the alternate embodiment of the D-ring 13, wherein its position is adjustable between ratchet adjusters 12, the D-ring will slide in the direction of the fall, and come to rest when it encounters a ratchet 12. At this point, any slack that is in the safety line 50 connecting the worker to the D-ring 13 will be taken up, and the force from the weight of the falling worker will be transferred through the strap 11 and to the gutter hook 18, which is connected to the soffit 40. In either embodiment, since the soffit 40 is a load bearing structure, it will securely hold the composite strap in place, thereby preventing the worker from impacting the ground therebelow and arrest his fall. The base of D-ring may also be thickened to prevent easy sliding along the length of the strap, whereby the tension on the strap compresses the D-ring base and the friction between the base and the roof and between the link and strap prevents easy movement without use of the attach loop. This may be desired, as a light fall will be arrested using the friction prior to contact with a strap ratchet.

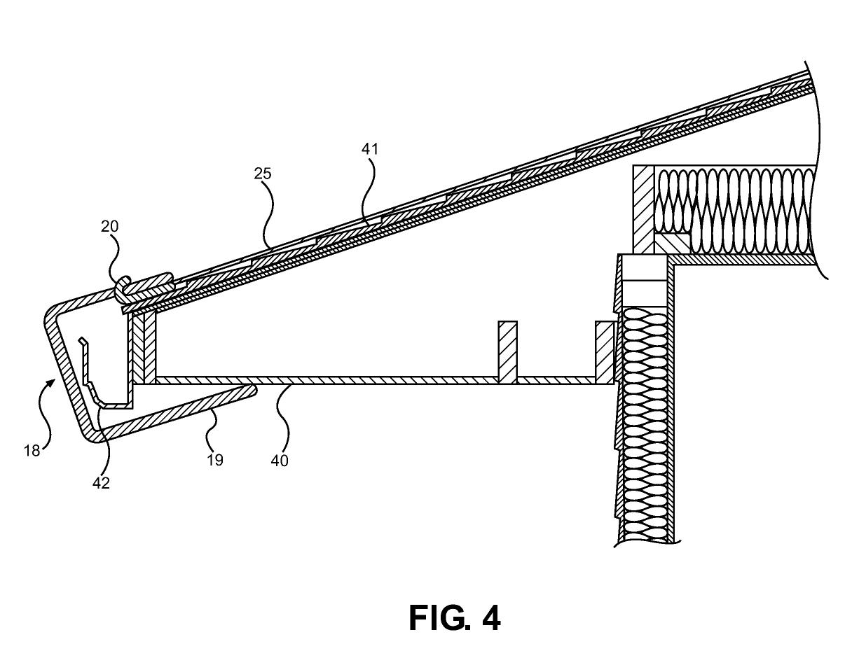

Referring now to FIG. 4, there is shown a cross-sectional side view of the hook attachment around a roof gutter. As shown, the device C-shaped hook 18 attaches around the periphery of an existing gutter 42, whereby the base of the hook 19 abuts against the roof soffit 40 without contacting the gutter 42 directly. This prevents load from being introduced into the gutter 42, which could cause considerable damage thereto and completely break the gutter free from the structure. The roof strap 25 and hook receiver 20 lie flat against the roof 41 due to the tension in the strap and the placement of the hook around the edge thereof.

Overall, the present invention provides a user with a conveniently and easily installable fall arresting and roof safety system for working on a roof or similar raised surface. The device utilizes a unique design that is quickly installable and affords protection to the roof and gutters in the event of a fall, along with a secure mounting point to support a fallen worker and prevent injury due to impact with a ground surface. The invention may be easily applied and removed from roofs without the use of fasteners or other permanent fixtures. The design of the strap terminal ends allows for a plurality of attachments for working on structures with different attachment points, which makes for a versatile and inexpensive safety system.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fall restraint device to arrest a fall, comprising:
a composite roof strap, comprising a central strap with two terminal ends and length adjustable straps attached to said central strap terminal ends;
said central strap and length adjustable strap attachment comprising strap tensioner means for connecting said straps and permitting slack adjustment of said length adjustable straps;
a safety line attachment along said central strap to affix a safety line thereto;
a roof gutter attachment means attached to each adjust strap terminal end, adapted to secure said adjustable strap to a first and second gutter location.

2) The device of claim 1, wherein said safety line attachment is slideable along said central strap between said strap tensioner means.

3) The device of claim 2, wherein said safety line attachment is a D-ring device with a base and an upstanding ring adapted to connect to a worker safety line.

4) The device of claim 1, wherein said safety line attachment is fixed along said central strap midlength between said strap tensioner means.

5) The device of claim 4, wherein said safety line attachment is a D-ring device with a base and an upstanding ring adapted to connect to a worker safety line.

6) The device of claim 1, wherein said strap tensioner means comprises strap ratchet devices.

7) The device of claim 1, wherein said adjustable strap terminal ends further comprises a U-shaped fitting with a plurality of apertures therethrough.

8) The device of claim 1, wherein:
said adjustable strap terminal ends further comprises a U-shaped fitting with a plurality of apertures therethrough;
a plurality of C-shaped hooks attached to a common bridge;
said hooks fitting through said fitting apertures and said bridge secured within said U-shape fitting;
said hooks adapted to fit around an existing gutter or roof termination and bear into a roof soffit.

9) The device of claim 8, wherein said U-shaped fitting and said bridge are fastenable together.

10) The device of claim 1, wherein:
said adjustable strap terminal ends further comprises a U-shaped fitting with a plurality of apertures therethrough;
a plurality of L-shaped hooks attached to a common bridge;
said hooks fitting through said fitting apertures and said bridge secured within said U-shape fitting;
a gutter wedge adapted to fit into the interior cavity of a gutter having a plurality of apertures therethrough;
said hooks adapted to fit into said gutter wedge apertures. 11) The device of claim 10, wherein said U-shaped fitting and said bridge are fastenable together.
